(19) United States
(12) Patent Application Publication
(10) Pub. No.: US 2008/0145048 A1
(43) Pub. Date: Jun. 19, 2008

(54) OPTICAL FIBER MONITORING SYSTEM AND METHOD INCORPORATED WITH AUTOMATIC FAULT PROTECTION MECHANISM

(76) Inventors: Hsuan-Hung Wu, Taipei (TW); Teng-Yuan Chi, Taipei (TW); Tien-Hsiang Lu, Taipei (TW); Wen-Ling Liao, Taipei (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/612,495

(22) Filed: Dec. 19, 2006

(51) Int. Cl. H04B 10/08; H04B 17/00

(52) U.S. Cl. 398/25

(57) ABSTRACT

The present invention provides an optical fiber monitoring system and method incorporated with an automatic fault protection mechanism. The optical fiber monitoring system includes a primary optical channel, a secondary optical channel, an optical channel fault examination device, a plurality of automatic fault protection devices, and a plurality of optical terminal equipments. When an automatic fault protection device detects a fault, it switches the connection of the optical terminal equipments from the primary optical channel to the secondary optical channel; meanwhile, a test optical channel is selected to be checked by the optical channel fault examination device.

### BACKGROUND OF THE INVENTION

1. Field of the Invention

The present invention relates to an optical fiber monitoring system and method, and more particularly to an optical fiber monitoring system and method incorporated with an automatic fault protection mechanism.

2. Description of the Prior Art

An optical channel fault examination device, such as an optical time-domain reflectometry (OTDR), is usually employed to help performing fiber monitoring in an optical communication system. An OTDR injects light into the optical fiber, and then graphically displays the results of detected back-reflected light. By measuring elapsed transit time of reflected light to calculate the distance to different events, an OTDR is capable of identifying the location of an optical cable fault. Fiber monitoring can be on-line or off-line. For on-line fiber monitoring, the optical fiber tested by an OTDR is a fiber in use. Therefore, the wavelengths of the optical testing signal and the transmission signal are different. On the other hand, an OTDR will test inactive fibers in an off-line mode monitoring.

FIG. 1A shows a conventional on-line optical fiber monitoring system 100A which includes an optical cable 110, optical communication terminals (OCTs) (120, 121), an optical time-domain reflectometry (OTDR) 130, an optical switch (OSW) 140, a central processing unit (CPU) 150, wavelength division multiplexers (WDMs) (160, 161), and a power measurement unit (PMU) 170. FIG. 1A illustrates the conventional on-line monitoring mechanism through a portion of the whole optical network. The whole optical network may contain more optical communication terminals, optical cables, as well as respective accompanying WDMs to form the entire communication system. The optical communication terminal 120 interchanges information with the optical communication terminal 121 through the WDM 160, the optical cable 110, and the WDM 161. The optical cable 110 may include a plurality of optical fibers. OSW 140 may be a one-to-many (or 1.times.N) switch. When the PMU 170 detects the vanishment of a regular optical power, the CPU 150 will switch the OSW 140 to select an optical fiber in the optical cable 110 to be tested by the OTDR 130 for identifying a fault location. Since it operates in on-line mode, the OTDR 130 performs the fault locating job in a wavelength different from the regular one.

FIG. 1B shows a conventional off-line optical fiber monitoring system 100B which includes an optical cable 110, an optical time-domain reflectometry (OTDR) 130, an optical switch (OSW) 140, a central processing unit (CPU) 150, a wavelength division multiplexer (WDM) 160, a power measurement unit (PMU) 170, and a light source unit (LSU) 180. Similarly, FIG. 1B illustrates the conventional off-line monitoring mechanism through a portion of the whole optical network. The whole optical network may contain more optical communication terminals, optical cables, as well as respective accompanying WDMs to form the entire communication system. Since there is no regular optical signal transmitting in the monitored optical fibers for off-line mode monitoring, it thus needs extra light source 180 to provide optical signal for real-time monitoring. When the PMU 170 fails to detect the optical signal, the CPU 150 will switch the OSW 140 to select an optical fiber in the optical cable 110 to be tested by the OTDR 130 for locating a fault position.

Although a fault position can be identified by using an OTDR, the conventional monitoring method suffers from a limitation on testing speed. It will typically take about one minute for an OTDR to finish testing a single fiber. Consequently, it will take about twenty minutes, for example, to finish testing an optical cable containing twenty fibers therein. Furthermore, during the OTDR testing period, the fault is not fixed or removed. The fault can not be repaired until it is successfully located, which needs extra time besides the time needed for OTDR testing. Yet furthermore, because the OTDR is generally an expensive apparatus, it is in fact a waste of resource for an OTDR to be used to repeatedly and routinely monitor normal fibers.

In view of foregoing drawbacks regarding conventional optical fiber monitoring, there is a need to provide new improvement. It is preferred for a new improvement to be able to remove or fix a fault or break event as soon as possible while the communication integrity is maintained. It is also preferred to make an OTDR never starting action when there is no fault existing to avoid over-consuming the lifetime of an expensive apparatus on unnecessary tasks.

### SUMMARY OF THE INVENTION

It is an object of the present invention to set forth an optical fiber monitoring system incorporated with an automatic fault protection mechanism and capable of maintaining the communication integrity while locating a fault.

It is another object of the present invention to set forth an auxiliary apparatus for an optical fiber monitoring system. The auxiliary apparatus provides an automatic fault protection mechanism such that the optical fiber monitoring system is capable of maintaining the communication integrity while locating a fault.

It is yet another object of the present invention to set forth an optical fiber monitoring method incorporated with an automatic fault protection mechanism.

In accordance with one of above objects, the present invention set forth an optical fiber monitoring system incorporated with an automatic fault protection mechanism. The optical fiber monitoring system includes a primary optical channel, a secondary optical channel, an optical channel fault examination device for examining a fault in optical channels, a plurality of automatic fault protection devices for monitoring a fault in the primary optical channel, and a plurality of optical terminal equipments connected with the primary optical channel through the plurality of automatic fault protection devices. When any of the plurality of automatic fault protection devices detects a fault in the primary optical channel, it switches the connection of the optical terminal equipments from the primary optical channel to the secondary optical channel, and meanwhile a target optical channel is selected to be checked by the optical channel fault examination device.

The present invention also provides an auxiliary apparatus for an optical fiber monitoring system. The auxiliary apparatus includes a transmitting optical channel switching device, a receiving optical channel switching device, and an optical power measuring device. The transmitting optical channel switching device is connected to an optical signal transmitting terminal of an optical terminal equipment in the optical fiber monitoring system as well as to a first primary optical channel; the receiving optical channel switching device being connected to an optical signal receiving terminal of the optical terminal equipment as well as to a second primary optical channel; the optical power measuring device being configured to monitor optical power in the second primary optical channel. When the optical power measuring device fails to detect optical power in the second primary optical channel, the transmitting optical channel switching device switches the connection of the first primary optical channel to an optical channel fault examination device, and the receiving optical channel switching device also switches the connection of the second primary optical channel to the optical channel fault examination device.

The Present Invention also provides an optical fiber monitoring method incorporated with an automatic fault protection mechanism, the method including: monitoring the optical power in a primary optical channel to determining if there is a fault in the primary optical channel; switching communication to a secondary optical channel and activating a fault locating process when the primary optical channel is determined to be faulty.

### BRIEF DESCRIPTION OF THE DRAWINGS

FIG. 1A shows a conventional on-line optical fiber monitoring system.

FIG. 1B shows a conventional off-line optical fiber monitoring system.

FIG. 2 shows an optical fiber monitoring system in accordance with an embodiment of the present invention.

FIGS. 3A and 3B show the internal structure and possible connection of the optical automatic switches in accordance with an embodiment of the present invention.

FIG. 3C shows the internal structure and possible connection of an optical automatic switch in accordance with another embodiment of the present invention.

FIG. 4 shows an optical fiber monitoring system in accordance with another embodiment of the present invention.

FIG. 5 shows the steps of an optical fiber monitoring method in accordance with an embodiment of the present invention.

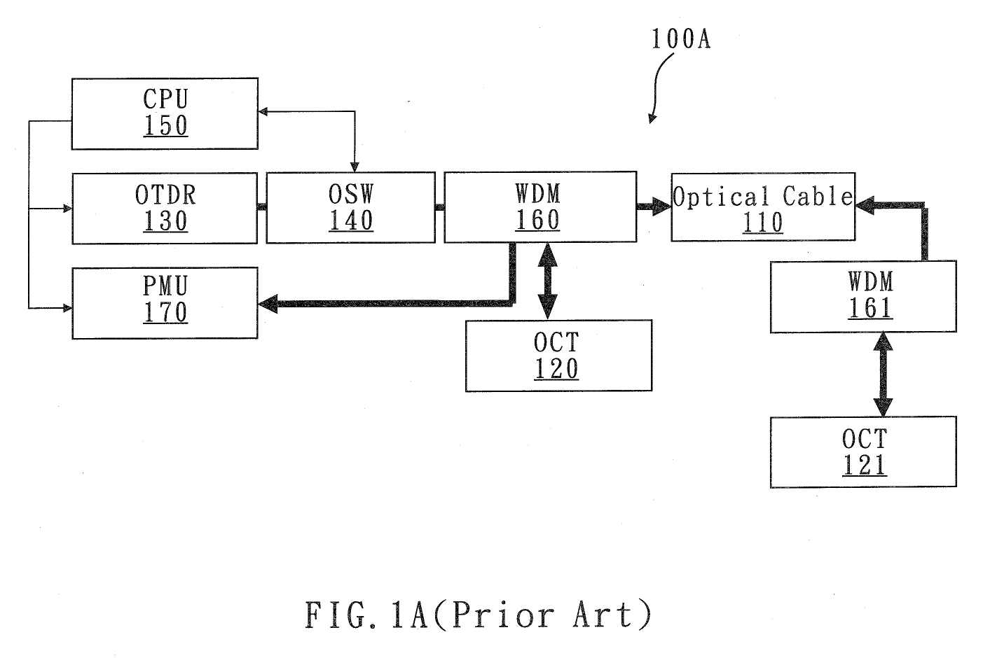

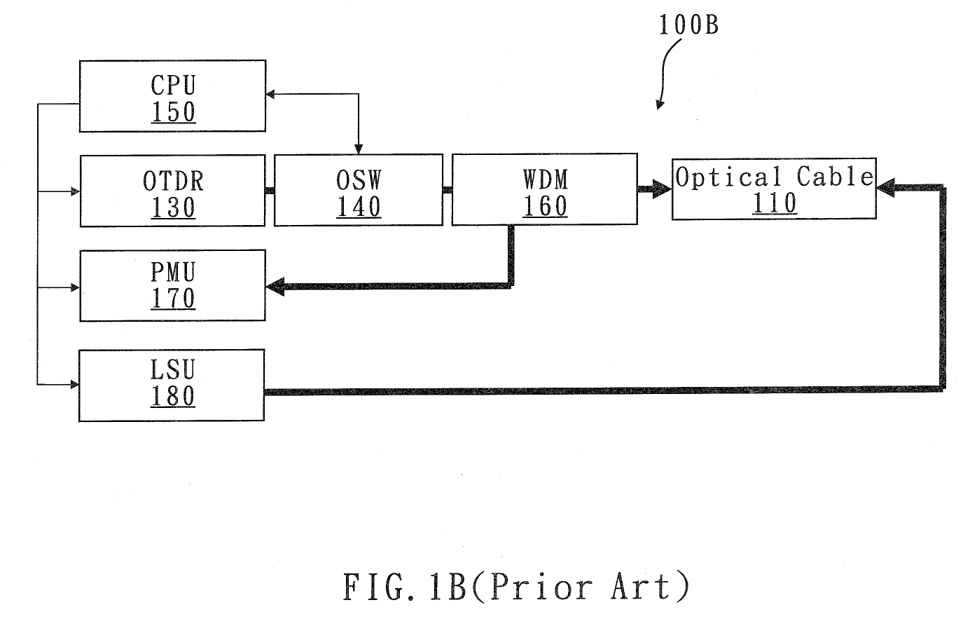

### DETAILED DESCRIPTION OF THE INVENTION

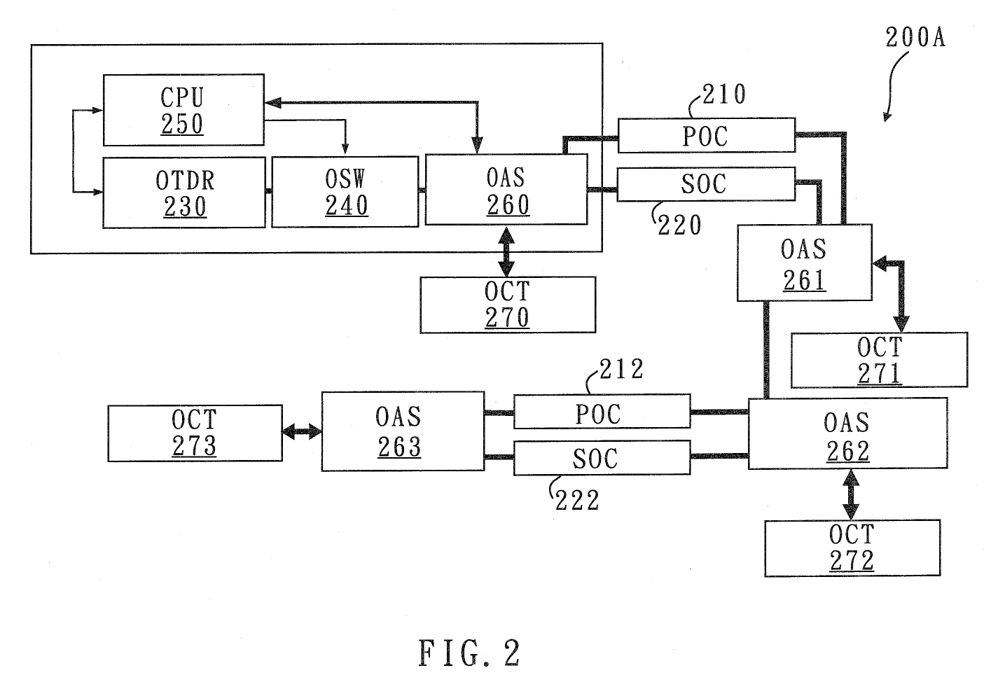

FIG. 2 shows an optical fiber monitoring system 200A in accordance with an embodiment of the present invention, including primary optical channels (POCs) (210, 212), secondary optical channels (SOCs) (220, 222), an optical time-domain reflectometry (OTDR) 230, an optical switch (OSW) 240, a central processing unit (CPU) 250, a plurality of optical automatic switches (OASs) (260-263), and a plurality of optical communication terminals (OCTS) (270-273). More primary optical channels, secondary optical channels, optical communication terminals, and optical automatic switches may be added into he optical fiber monitoring system 200A to form an overall optical communication network. The CPU 250 connects to and controls the OTDR 230, the optical switch 240, and the optical automatic switch 260. The OTDR 230 is connected to the optical switch 240. The optical switch 240 is in turn connected to the optical automatic switch 260. The optical automatic switch 260 is connected to the optical communication terminal 270, the primary optical channel 210, and the secondary optical channel 220. The primary optical channel 210 and the secondary optical channel 220 are connected to the optical automatic switch 261. The optical automatic switch 261 is connected to another optical automatic switch 262 and the optical communication terminal 271. The optical automatic switch 262 is connected to the primary optical channel 212, the secondary optical channel 222, and the optical communication terminal 272. The primary optical channel 212 and the secondary optical channel 222 are connected to the optical automatic switch 263. Finally, the optical automatic switch 263 is connected to the optical communication terminal 273.

The primary optical channels (210, 212) and the secondary optical channels (220, 222) may be optical fibers respectively located in two different optical cables, or may be different optical fibers located in the same optical cable. The optical communication terminal 270 (or referred to as the optical terminal equipment in this specification) may be a host optical transmitting/receiving module which refers a module generally called an optical line terminal (OLT) in optical network technology. The optical communication terminals (271-273) may be client optical transmitting/receiving modules which refer to modules generally called optical network units (ONUs). The optical switch 240 may be a one-to-many optical switch, one of connecting ends thereof being coupled to the optical automatic switch 260. The optical automatic switches 260-263 are modules capable of optical channel switching and optical power measuring. Functioning as optical power monitoring and automatic fault protection devices, the optical automatic switches 260-263 act as auxiliary apparatuses for the optical fiber monitoring system in accordance with the present invention. During normal operation, the optical channel switching capability of the optical automatic switch 260 may be configured to connect the primary optical channel 210 to the optical communication terminal 270 and connect the secondary optical channel 220 to the optical switch 240 while monitoring the optical power traveling through the primary optical channel in the meantime. As a break or fault occurs in the primary optical channel 210, the optical power under detection by the optical automatic switch 260 will disappear or unusually attenuate. At this moment, the optical automatic switch 260 automatically switches so as to connect the primary optical channel 210 to the optical switch 240, and meanwhile connect the secondary optical channel 220 to the optical communication terminal 270 such that the communication integrity is protected and maintained. The optical automatic switch 261 also switches to connect the optical communication terminal 271 to the secondary optical channel 220 as soon as the monitored optical power disappears or unusually attenuates.

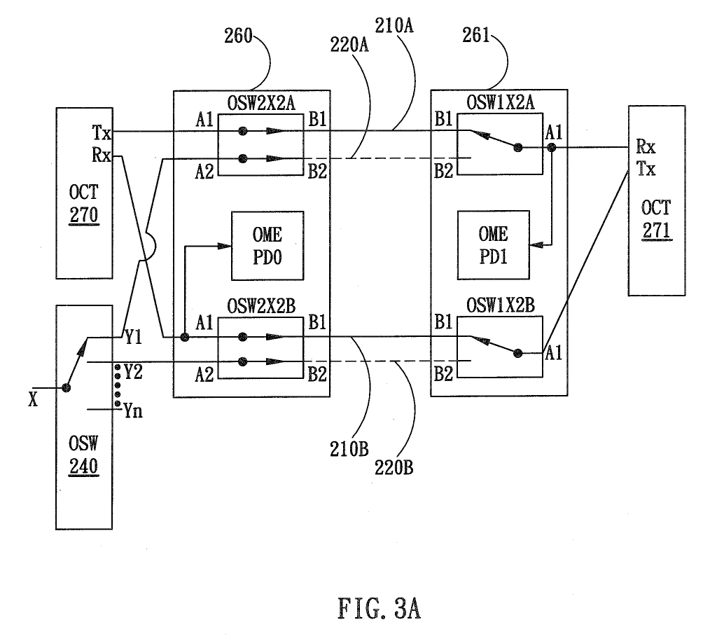

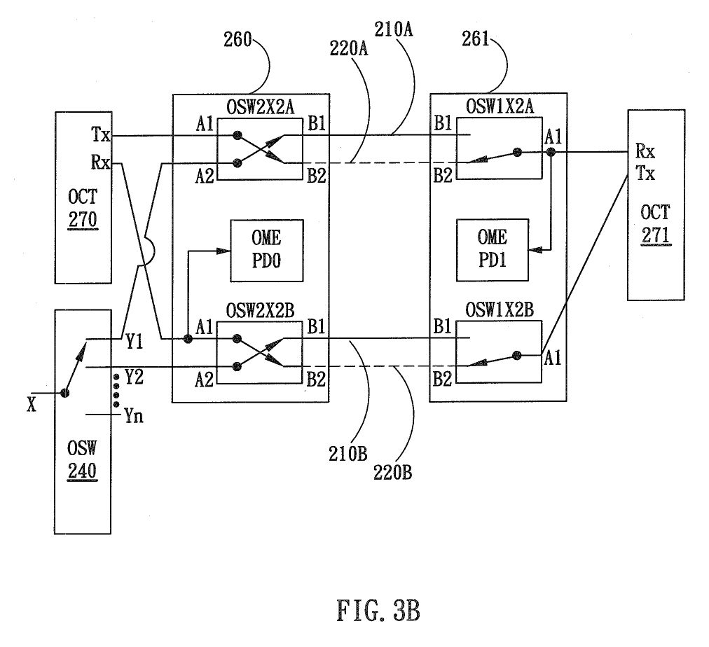

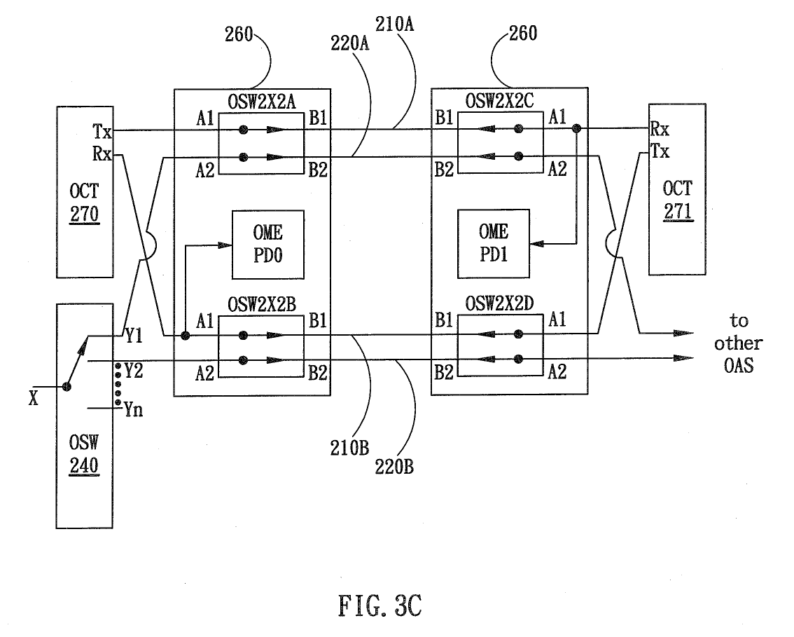

In accordance with the present invention, the primary optical channel (210, 212) and the secondary optical channel (220, 222) may respectively include a pair of transmitting/receiving fibers as illustrated in embodiments below. FIG. 3A shows the internal structure and possible connection of optical automatic switches 260 and 261 illustrating the main components therein and an exemplified connection therebetween and to external modules in accordance with an embodiment of the present invention, which is basically a more detailed illustration regarding to the interaction among the optical automatic switches (OASs) (260, 261), the optical communication terminals (OCTs) (270, 271), the optical switch (OSW) 240, the primary optical channel 210 and the secondary optical channel 220 shown in FIG. 2. The primary optical channel 210 in FIG. 2 is now represented as a first primary optical channel 210A and a second primary optical channel 210B. Likewise, the secondary optical channel 220 is represented as a first secondary optical channel 220A and a second secondary optical channel 220B. The first primary optical channel 210A and the first secondary optical channel 220A are used to transmit the optical signals from the optical communication terminal 270 to the optical communication terminal 271, while the second primary optical channel 210B and the second secondary optical channel 220B are used to transmit the optical signals from the optical communication terminal 271 to the optical communication terminal 270.

As shown in FIG. 3, the optical automatic switch 260 includes a two-by-two optical switch OSW2X2A, a two-by-two optical switch OSW2X2B, and an optical measuring element (OME) PD0. The optical switches OSW2X2A and OSW2X2B respectively contain four terminals A1, A2, B1, B2, and can toggle between a first state and a second state. In the first state, the terminal A1 is connected to terminal B1 (and terminal A2 to B2). In the second state, on the contrary, the terminal A1 will be connected to terminal B2 (and terminal A2 to B1). The optical switches OSW2X2A and OSW2X2B shown in FIG. 3A, for example, are both in the first state. The optical automatic switch 261 includes a one-by-two optical switch OSW1X2A, a ono-by-two optical switch OSW1X2B, and an optical measuring element (OME) PD1. The optical switches OSW1X2A and OSW1X2B respectively contain three terminals A1, B1, B2, and can also toggle between the first state and the second state. Similar to OAS 260, the first state connects the terminal A1 to terminal B1, and the second state connects the terminal A1 to terminal B2. The optical switches OSW1X2A and OSW1X2B shown in FIG. 3A, for example, are both in the first state. The optical communication terminals 270 and 271 respectively include a transmitting terminal Tx and a receiving terminal Rx. The optical switch 240 includes n+1 terminals X, Y1, Y2, . . . , Yn and is capable of switching among n states, each state connecting the X terminal to one of the Y1 through Yn terminals. The optical measuring elements PD0 and PD1 may be, but not limit to, photo diodes.

The connection between modules in FIG. 3A will be described now. The transmitting terminal Tx and the receiving terminal Rx of the optical communication terminal 270 are respectively connected to the A1 terminal of the two-by-two optical switch OSW2X2A and the A1 terminal of the two-by-two optical switch OSW2X2B. The B1 terminal and B2 terminal of the two-by-two optical switch OSW2X2A are respectively connected to the B1 terminal and B2 terminal of the one-by-two optical switch OSW1X2A respectively through the first primary optical channel 210A and the first secondary optical channel 220A. The A1 terminal of the one-by-two optical switch OSW1X2A is connected to the receiving terminal Rx of the optical communication terminal 271. The B1 terminal and B2 terminal of the two-by-two optical switch OSW2X2B are respectively connected to the B1 terminal and B2 terminal of the one-by-two optical switch OSW1X2B respectively through the second primary optical channel 210B and the second secondary optical channel 220B. The A1 terminal of the one-by-two optical switch OSW1X2B is connected to the transmitting terminal Tx of the optical communication terminal 271. The optical measuring elements PD0 and PD1 are respectively connected to the A1 terminal of the two-by-two optical switch OSW2X2B and the A1 terminal of the one-by-two optical switch OSW1X2A. The X terminal of the optical switch 240 is connected to the OTDR 230 (not shown in FIG. 3A), the Y1 terminal and Y2 terminal thereof being respectively connected to the A2 terminal of the two-by-two optical switch OSW2X2A and the A2 terminal of the two-by-two optical switch OSW2X2B. Since the terminals Y1 through Yn of the optical switch 240 are symmetric to each other, it is feasible to arbitrarily select two terminals therefrom to be respectively connected to the A2 terminal of the two-by-two optical switch OSW2X2A and the A2 terminal of the two-by-two optical switch OSW2X2B.

As described above, the two-by-two optical switches OSW2X2A and OSW2X2B as well as the one-by-two optical switches OSW1X2A and OSW1X2B are all in the first state. In other words, communication between the optical communication terminals 270 and 271 is through the first primary optical channel 210A and the second primary optical channel 210B. Specifically, the optical signals from the transmitting terminal Tx of the OCT 270 is transmitted to the receiving terminal Rx of the OCT 271 through the first primary optical channel 210A, while being monitored by the optical measuring element PD1 through the A1 terminal of the optical switch OSW1X2A. On the other hand, the optical signals from the transmitting terminal Tx of the OCT 271 is transmitted to the receiving terminal Rx of the OCT 270 through the second primary optical channel 210B, while being monitored by the optical measuring element PD0 through the A1 terminal of the optical switch OSW1X2B.

If the primary optical channel 210 should break somewhere, the communication through the first primary optical channel 210A and/or the second primary optical channel 210B will stop, and the optical measuring element PD0 and/or PD1 will fail to detect regular optical power. At this moment, the two-by-two optical switches OSW2X2A and OSW2X2B as well as the one-by-two optical switches OSW1X2A and OSW1X2B will be toggled to the second state as illustrated by FIG. 3B. In other words, when a break occurs in the primary optical channels 210A/210B, the optical automatic switches 260 and 261 will immediately switch the optical communication between the optical communication terminals 270 and 271 to be through the secondary optical channels 220A/220B and meanwhile switch the connection of the primary optical channel 210A/210B to the optical switch 240 such that an OTDR (not shown in FIG. 3A and FIG. 3B) can be used to check the fault location in the primary optical channel. In contrast to the conventional manner, the present invention is capable of automatic protection to keep the communication integrity in real time as soon as a fault is detected. Moreover, the time-consuming OTDR test procedure is only activated when necessary to achieve a more efficient mechanism. In addition, the present invention does not need any expensive wavelength division multiplexer (WDM) so that the overall cost is further saved.

The two one-by-two optical switches OSW1X2A and OSW1X2B can be replaced by two two-by-two optical switches OSW2X2C and OSW2X2D to incorporate other optical communication terminal into the system through other optical automatic switch, as illustrated in FIG. 3C. Those skilled in the art will appreciate that the optical system can be flexibly extended in the manner as shown in FIG. 3C.

In accordance with another embodiment of the present invention, each of the two-by-two optical switches OSW2X2A and OSW2X2B may be replaced by two one-by-two optical switches.

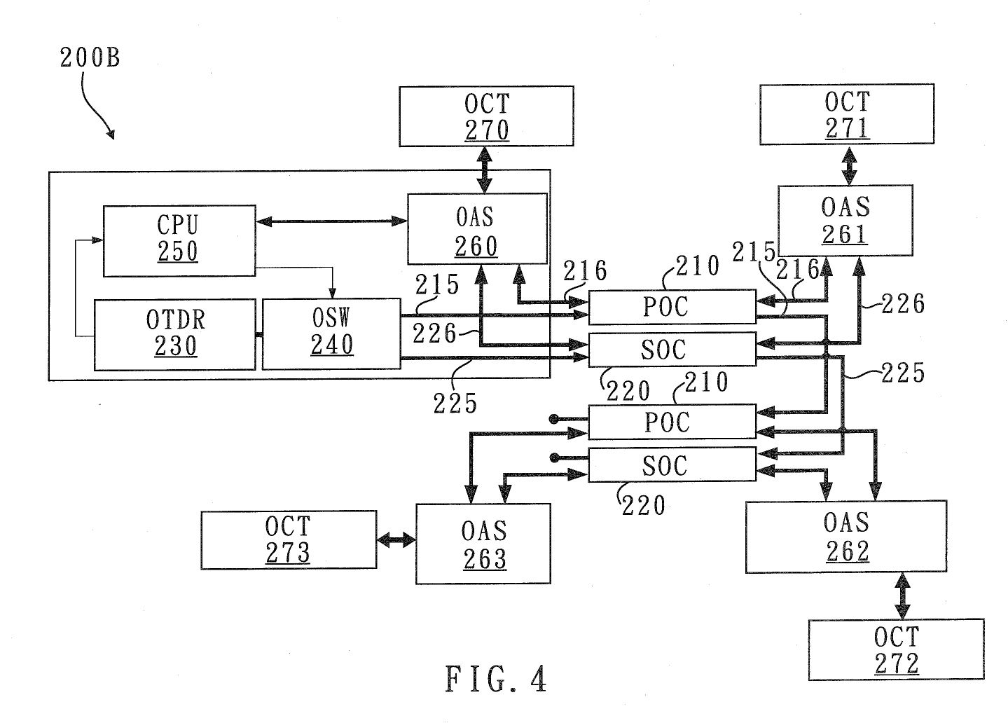

FIG. 4 shows an optical fiber monitoring system 200B in accordance with another embodiment of the present invention, including a primary optical cable (POC) 210, a secondary optical cable (SOC) 220, an optical time-domain reflectometry (OTDR) 230, an optical switch (OSW) 240, a central processing unit (CPU) 250, a plurality of optical automatic switches (OASs) 260-263, and a plurality of optical communication terminal (OCTs) 270-273. The primary optical cable 210 includes a test optical channel 215 and an active optical channel 216. The secondary optical cable 220 includes a test optical channel 225 and an active optical channel 226. The CPU 250 connects to and controls the OTDR 230, the optical switch 240, and the optical automatic switch 260. The OTDR 230 is connected to the optical switch 240. The optical switch 240 is in turn connected to the primary test optical channel 215 and the secondary test optical channel 225. The optical automatic switch 260 is connected to the optical communication terminal 270, the primary active optical channel 216 and the secondary active optical channel 226. The primary active optical channel 216 and the secondary active optical channel 226 are connected to the optical automatic switch 261. The optical automatic switch 261 is in turn connected to the optical communication terminal 271. The optical automatic switch 262 is connected to the primary active optical channel 216, the secondary active optical channel 226, and the optical communication terminal 272. The primary active optical channel 216 and the secondary active optical channel 226 are connected to the optical automatic switch 263. The optical automatic switch 263 is connected to the optical communication terminal 273. The test optical channels and active optical channels may be optical fibers in optical cables. As described above, in practice, an optical channel generally includes a pair of transmitting/receiving optical fibers.

Operation of FIG. 4 is similar to FIG. 2, FIG. 3A, and FIG. 3B. In general, when the primary optical cable 210 breaks, the optical automatic switches 260-263 will switch the active communication to the secondary optical cable 220 such that the communication integrity can be kept. The CPU 250 is then informed to do something. The major difference in this embodiment is that the OTDR 230 is only connected to the test optical channel 215 in the primary optical cable 210 and the test optical channel 225 of the secondary optical cable 220 through the optical switch 240. In other words, although located in the same optical cable, the fiber (optical channel) tested by the OTDR 230 is different from the faulty fiber detected by the optical automatic switches 260-263. However, since all fibers in a cable tend to being broken concurrently while the cable breaking, such an off-line monitoring mode is useful in practical situation. Moreover, due to the tiny number of monitoring fibers, the off-line mode system is advantageous in cost.

The embodiments illustrated in FIG. 2 and FIG. 4 are corresponding to the conventional on-line and off-line monitoring mode respectively. Other embodiments in accordance with the present invention may combine both the on-line and off-line modes. Based on practical situation, a portion of fibers in a cable may be on-line monitored while another portion of fibers in the cable may be off-line monitored.

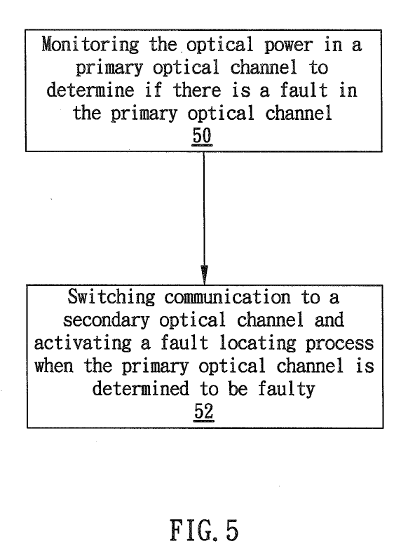

Based on above disclosure, the present invention set forth an optical fiber monitoring method incorporated with an automatic fault protection mechanism. FIG. 5 shows the steps of an optical fiber monitoring method in accordance with an embodiment of the present invention, including monitoring the optical power in a primary optical channel to determine if there is a fault in the primary optical channel (step 50); and switching communication to a secondary optical channel and activating a fault locating process when the primary optical channel is determined to be faulty (step 52). The monitoring on optical power may be achieved by an optical power measuring device such as a photo diode. The fault locating process may include selecting a test optical channel and identifying a fault location in the test optical channel by an optical channel fault examination device such as an OTDR. Depending on system design methodology, the selected test optical channel may be an active optical fiber acting as a primary optical channel (on-line) or other optical fiber located in the same cable containing the primary optical channel (off-line).

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An optical fiber monitoring system with automatic fault protection mechanism, comprising:
a primary optical channel;
a secondary optical channel;
an optical channel fault examination device, for locating a fault position in optical channels;
a plurality of automatic fault protection devices, for monitoring a fault event in said primary optical channel;
a plurality of optical terminal equipments, connecting to said primary optical channel through said plurality of automatic fault protection devices;
wherein said plurality of optical terminal equipments are switched from said primary optical channel to said secondary optical channel and a test optical channel is selected for fault position locating by using said optical channel fault examination device when said plurality of automatic fault protection devices determines that said primary optical channel is faulty.

2. The optical fiber monitoring system of claim 1, wherein said optical channel fault examination device is an optical time-domain reflectometry (OTDR).

3. The optical fiber monitoring system of claim 2, wherein said test optical channel is selected through an optical switch.

4. The optical fiber monitoring system of claim 2, wherein one of said plurality of automatic fault protection devices comprises a two-by-two optical switch for switching connection between said primary optical channel and said secondary optical channel.

5. The optical fiber monitoring system of claim 2, wherein each of said plurality of automatic fault protection devices comprises an optical power measuring device for monitoring a fault event in optical channels.

6. The optical fiber monitoring system of claim 5, wherein said test optical channel is said primary optical channel.

7. The optical fiber monitoring system of claim 5, wherein said test optical channel is an optical channel located in an optical cable comprising said primary optical channel.

8. The optical fiber monitoring system of claim 5, wherein said optical power measuring device is a photo diode.

9. An auxiliary apparatus for an optical fiber monitoring system, comprising:
a transmitting optical channel switching device, connecting to an optical signal transmitting terminal of an optical terminal equipment and a first primary optical channel of the optical fiber monitoring system;
a receiving optical channel switching device, connecting to an optical signal receiving terminal of the optical terminal equipment and a second primary optical channel;
an optical power measuring device for monitoring optical power in the second primary optical channel;
wherein said transmitting optical channel switching device is switched to connect the first primary optical channel to an optical channel fault examination device and said receiving optical channel switching device is also switched to connect the second primary optical channel to the optical channel fault examination device when said optical power measuring device fails to detect the optical power in the second primary optical channel during normal operation.

10. The auxiliary apparatus of claim 9, wherein the optical channel fault examination device is an optical time-domain reflectometry (OTDR).

11. The auxiliary apparatus of claim 10, wherein said transmitting optical channel switching device and/or said receiving optical channel switching device comprises two-by-two optical switches.

12. The auxiliary apparatus of claim 10, wherein said transmitting optical channel switching device and/or said receiving optical channel switching device respectively comprises two one-by-two optical switches.

13. The auxiliary apparatus of claim 9, wherein the first primary optical channel and the second primary optical channel are connected to the optical channel fault examination device through an optical switch.

14. The auxiliary apparatus of claim 9, wherein said optical power measuring device is a photo diode.

15. An optical fiber monitoring method with automatic fault protection mechanism, comprising:
monitoring optical power in a primary optical channel to determine if there is a fault in the primary optical channel;
switching communication to a secondary optical channel and activating a fault locating process when the primary optical channel is determined to be faulty.

16. The method of claim 15, wherein said fault locating process comprising selecting a test optical channel and using an optical channel fault examination device to locate a fault position in the test optical channel.

17. The method of claim 16, wherein said optical channel fault examination device is an optical time-domain reflectometry (OTDR).

18. The method of claim 17, wherein said test optical channel is said primary optical channel.

19. The method of claim 17, wherein said test optical channel is an optical channel located in an optical cable comprising said primary optical channel.

20. The method of claim 16, wherein said test optical channel is selected through an optical switch.

21. The method of claim 15, wherein said optical power is monitored by a photo diode.
